(19) United States
(12) Patent Application Publication
(10) Pub. No.: US 2026/0217262 A1
(43) Pub. Date: Jul. 30, 2026

(54) VEHICLE CONTROL APPARATUS

(71) Applicant: TOYOTA JIDOSHA KABUSHIKI KAISHA, Toyota-shi (JP)

(72) Inventor: Akifumi TSUKAMOTO, Toyoake-shi (JP)

(73) Assignee: TOYOTA JIDOSHA KABUSHIKI KAISHA, Toyota-shi (JP)

(21) Appl. No.: 19/413,181

(22) Filed: Dec. 9, 2025

(30) Foreign Application Priority Data
Jan. 28, 2025 (JP) 2025-012187

(51) Int. Cl. B60W 50/00; B60W 40/08; G06V 20/59; G06V 40/10; G06V 40/20

(52) U.S. Cl. CPC B60W 50/0098; B60W 40/08; G06V 20/593; G06V 40/10; G06V 40/20; B60W 2040/0881; B60W 2420/403; B60W 2540/227

(57) ABSTRACT

A vehicle control apparatus is provided for executing an in-cabin space mode in which a plurality of in-vehicle devices provided in a vehicle operate cooperatively. The vehicle control apparatus includes an acquisition unit that acquires movement information regarding a user’s movement within the vehicle, a determination unit that determines whether the user has moved to a rear seat of the vehicle based on the movement information, and a control unit that executes a start process for starting the in-cabin space mode when the determination unit determines that the user has moved to the rear seat.

### TECHNICAL FIELD

The present disclosure relates to a vehicle control apparatus. BACKGROUND

### BACKGROUND

A vehicle control apparatus mounted on a vehicle and capable of executing an in-cabin space mode (hereinafter, sometimes simply referred to as the "in-cabin space" mode), in which a plurality of in-vehicle devices provided in the vehicle operate cooperatively, is known as related art. For example, the vehicle control apparatus described in Japanese Patent Application Laid-Open No. 2018-85686 ascertains the status of the vehicle based on operation amount and operation position information acquired by a human-machine interface (HMI), and executes cooperative control (for example, the in-cabin space mode) according to the status of the vehicle.

### SUMMARY

A user may, when executing the in-cabin space mode, for example, move to a rear seat of the vehicle to ensure privacy, and then start the in-cabin space mode from the rear seat. However, in the above vehicle control apparatus, to start the in-cabin space mode, the user must operate the HMI located in the front seat from the rear seat, which can be inconvenient. Therefore, it is desirable to improve the convenience of a user who uses the in-cabin space mode in the above vehicle control apparatus.

Accordingly, an object of the present disclosure is to provide a control apparatus capable of improving the convenience of a user who uses the in-cabin space mode.

A vehicle control apparatus according to the present disclosure is mounted on a vehicle and executes an in-cabin space mode in which a plurality of in-vehicle devices provided in the vehicle operate cooperatively. The vehicle control apparatus comprises:an acquisition unit that acquires movement information regarding a user’s movement within the vehicle; a determination unit that determines, based on the movement information, whether the user has moved to a rear seat of the vehicle; and a control unit that executes a start process for starting the in-cabin space mode when the determination unit determines that the user has moved to the rear seat.

In the vehicle control apparatus according to the present disclosure, in the start process the control unit requests consent to start the in-cabin space mode from the user, and may start the in-cabin space mode when consent is received from the user.

According to the present disclosure, it is possible to provide a vehicle control apparatus capable of improving the convenience of a user who uses the in-cabin space mode.

### BRIEF DESCRIPTION OF THE DRAWINGS

FIG. 1 is a block diagram showing a configuration of a vehicle control system including a vehicle control apparatus according to an example.

FIG. 2 is a flowchart showing an example of processing executed by the vehicle control apparatus in FIG. 1.

### DETAILED DESCRIPTION

Hereinafter, an example will be described in detail with reference to the drawings. In the description of the drawings, the same or corresponding parts are designated by the same reference signs, and redundant description may be omitted.

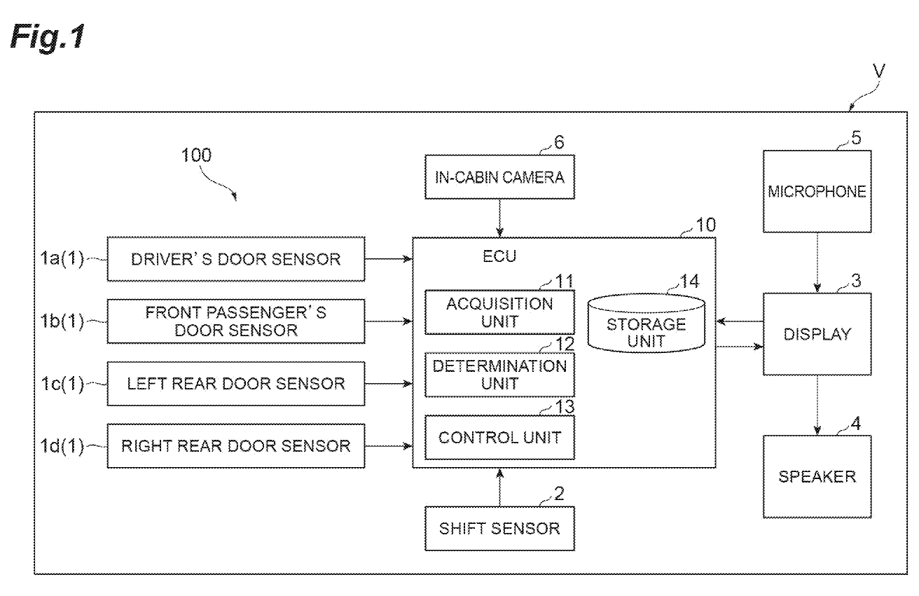

FIG. 1 is a block diagram showing a configuration of a vehicle control system 100 including an ECU (Electronic Control Unit) 10 (vehicle control apparatus) according to the example. The vehicle control system 100 shown in FIG. 1 is mounted on a vehicle V and is capable of starting and ending the in-cabin space mode described later.

ECU 10 comprehensively controls the vehicle control system 100. ECU 10 is an electronic control unit having a CPU (Central Processing Unit), ROM (Read Only Memory), RAM (Random Access Memory), a CAN (Controller Area Network) communication circuit, and the like. In ECU 10, for example, a program stored in the ROM is loaded into the RAM, and various functions are implemented by the CPU executing the program loaded into the RAM.

ECU 10 may be composed of a plurality of electronic units. Some of the functions of ECU 10 described below may be executed on a server capable of communicating with vehicle V. The functional configuration and processing details of ECU 10 will be described later. Connected to ECU 10 are a door sensor 1, a shift sensor 2, a touch panel display 3, a speaker 4, and a microphone 5. In the present example, ECU 10 serves as an interface that enables data exchange among the devices connected to ECU 10.

Door sensor 1 is a sensor that detects the opening and closing of each door of vehicle V. Door sensor 1 generates door open/close information indicating whether each door of vehicle V is in an open state, and transmits the door open/close information to ECU 10. Specifically, door sensor 1 includes a driver’s door sensor 1a, a front passenger’s door sensor 1b, a left rear door sensor 1c, and a right rear door sensor 1d. Door sensor 1 generates door open/close information for each of the driver’s door, the front passenger’s door, the left rear door, and the right rear door, and transmits that information to ECU 10.

Shift sensor 2 is a sensor that detects a shift operation by the driver. Shift sensor 2 generates operation information relating to the driver’s shift operation and transmits the operation information to ECU 10. For example, shift sensor 2 detects the position of the shift lever of vehicle V, namely the shift range, and generates operation information including information indicating the detected shift range. The shift ranges include a D range for forward driving, an N range for disconnecting the engine from the drive system, an R range for reverse, and a P range which locks the transmission internally to prevent vehicle V from moving.

Touch panel display 3 is connected to ECU 10 so as to allow input and output of information. Touch panel display 3 may, for example, be a center display or a Multi Information Display (MID). Touch panel display 3 displays various information according to control signals from ECU 10. Note that a Head-Up Display (HUD) may be connected to ECU 10 instead of the touch panel display 3.

Speaker 4 outputs audio or the like in the cabin of vehicle V. Specifically, speaker 4 receives control signals from ECU 10 via touch panel display 3 and outputs audio based on those control signals. Microphone 5 is an audio sensor that acquires sounds inside vehicle V. Microphone 5 acquires in-cabin sounds, such as occupant voices including the driver’s voice, and transmits recorded information indicating the acquired sounds to ECU 10 via touch panel display 3.

ECU 10 is a control apparatus for executing the in-cabin space mode. The in-cabin space mode is a mode in which a plurality of in-vehicle devices provided in vehicle V operate cooperatively (for example, a mode in which those devices are collectively controlled by ECU 10). The plurality of in-vehicle devices include, for example, speakers and an air conditioner. For example, in the in-cabin space mode, when an driver (user) rests in a target seat, ECU 10 controls the devices so that the driver can remain comfortable. Note that the in-cabin space mode is not limited to this example and may be any known mode.

ECU 10 includes an acquisition unit 11, a determination unit 12, a control unit 13, and a storage unit 14. The operations of each functional unit of ECU 10 will be specifically described. ECU 10 controls touch panel display 3, speaker 4, and microphone 5 based on detection results from door sensor 1 and shift sensor 2, and executes the following control.

Acquisition unit 11 acquires movement information regarding the driver’s movement within vehicle V. Acquisition unit 11 stores the acquired movement information in storage unit 14. The movement information includes the door open/close information described above. For example, the movement information includes information indicating whether a front seat door (the driver’s door or the front passenger’s door) is in an open state, and information indicating whether a rear seat door (the left rear door or the right rear door) is in an open state. The movement information also includes operation information indicating the shift range. For example, the movement information includes information indicating whether the shift range has changed to a range other than the P range. Acquisition unit 11 also acquires recorded information from microphone 5 and stores the recorded information in storage unit 14.

Determination unit 12 determines, based on the movement information, whether the driver has moved to a rear seat of vehicle V. Specifically, when the movement information indicates that a rear seat door of vehicle V is in an open state, determination unit 12 determines that the driver has moved to the rear seat. For example, determination unit 12 determines that the driver has moved to the rear seat when the driver’s door opens and then a rear seat door opens. Determination unit 12 also determines whether the driver has moved from the rear seat based on the movement information. Specifically, determination unit 12 determines that the driver has moved from the rear seat when a rear seat door opens and then the driver’s door opens, or when the shift range changes to a range other than the P range.

Control unit 13 executes a start process for starting the in-cabin space mode when determination unit 12 determines that the driver has moved to the rear seat. Control unit 13 ends the in-cabin space mode when determination unit 12 determines that the driver has moved from the rear seat after the in-cabin space mode has started.

The start process by control unit 13 will be described in detail. During the start process, control unit 13 requests consent from the driver to start the in-cabin space mode, and when consent is received from the driver, starts the in-cabin space mode. For example, control unit 13 outputs audio via speaker 4 requesting consent from the driver to start the in-cabin space mode. Control unit 13 determines that consent has been received from the driver based on the recorded information acquired by acquisition unit 11 and starts the in-cabin space mode. Note that control unit 13 may also receive an instruction specifying a target seat for the in-cabin space mode together with consent to start, and start the in-cabin space mode for the specified target seat.

Storage unit 14 stores information acquired by acquisition unit 11 and details of control executed by ECU 10. Storage unit 14 stores the movement information and recorded information. Storage unit 14 also stores the types of and control contents for the plurality of in-vehicle devices that control unit 13 activates when vehicle V enters the in-cabin space mode. Storage unit 14 is implemented by the ROM and RAM and the like of ECU 10.

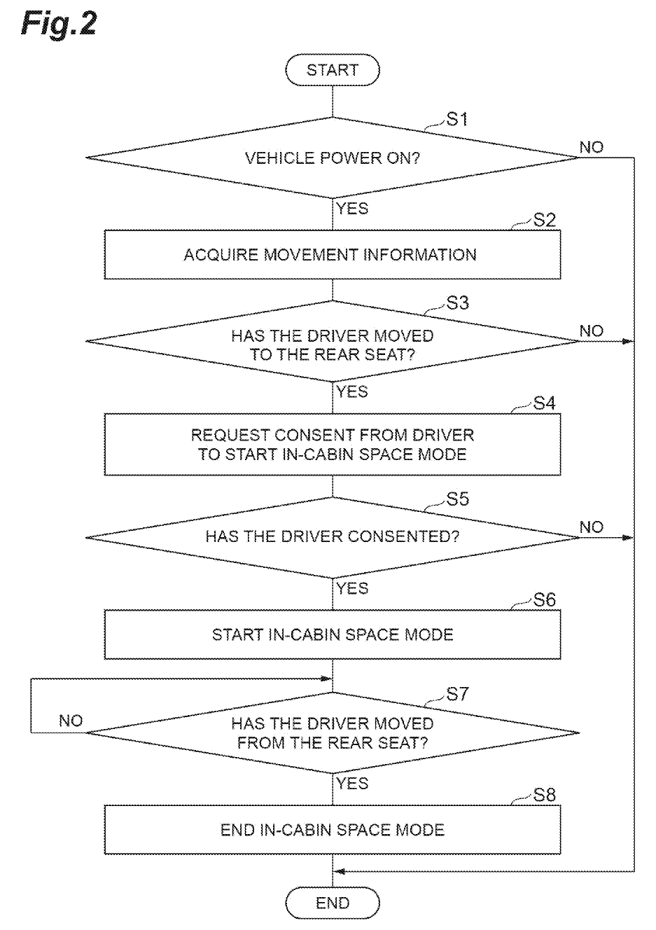

Next, a processing method of ECU 10 according to the present example will be described. FIG. 2 is a flowchart showing an example of processing for starting and ending the in-cabin space mode. The processing for starting and ending the in-cabin space mode is executed periodically. Specifically, in the processing for starting and ending the in-cabin space mode, processes S1 to S8 are repeatedly executed. Note that the user may enable or disable the processing for starting and ending the in-cabin space mode. For example, if the user finds this processing bothersome, it may be disabled.

As shown in FIG. 2, in S1 ECU 10 determines whether the vehicle power of vehicle V is ON. When ECU 10 determines that the vehicle power is ON (S1: YES), it moves to S2. When ECU 10 determines that the vehicle power is OFF (S1: NO), the processing of the current cycle ends and proceeds to S1 of the next cycle.

In S2, ECU 10 acquires movement information. For example, ECU 10 acquires door open/close information from door sensor 1 and operation information from shift sensor 2. Thereafter, ECU 10 moves to S3.

In S3, ECU 10 determines whether the driver has moved to the rear seat of vehicle V. When ECU 10 determines that the driver has moved to the rear seat (S3: YES), in S4 it requests consent from the driver to start the in-cabin space mode and then moves to S5. When ECU 10 determines that the driver has not moved to the rear seat (S3: NO), the processing of the current cycle ends and proceeds to S1 of the next cycle.

Thus, in the processes S1 to S4, ECU 10, when the vehicle power is ON and the driver’s door opens followed by a rear seat door opening, proposes to the driver that the in-cabin space mode be started. In this case, when the driver moves from the driver’s seat to the rear seat, it is possible to reliably propose starting the in-cabin space mode. In other words, ECU 10 determines the timing to start and end the in-cabin space mode based on door open/close states.

In S5, ECU 10 determines whether consent has been received from the driver. Specifically, if consent has not been received from the driver and a predetermined waiting time has elapsed, ECU 10 determines that consent has not been received. The predetermined waiting time is preset by the driver or the like. If consent has been received from the driver, ECU 10 determines that consent has been received.

When ECU 10 determines that consent has been received (S5: YES), in S6 it starts the in-cabin space mode and then moves to S7. In this case, ECU 10 acquires recorded information and, based on the recorded information, receives both consent to start the in-cabin space mode and an instruction for the target seat from the driver. If ECU 10 determines that consent has not been received (S5: NO), the processing of the current cycle ends and proceeds to S1 of the next cycle.

In S7, ECU 10 determines whether the driver has moved from the rear seat. When ECU 10 determines that the driver has not moved (S7: NO), S7 is executed again. When ECU 10 determines that the driver has moved from the rear seat (S7: YES), in S8 it ends the in-cabin space mode, ends the processing of the current cycle, and proceeds to S1 of the next cycle.

In the processes S7 and S8, while the in-cabin space mode is being executed (for example, after consent has been received), if the driver’s door opens or the shift range changes to a range other than the P range, ECU 10 ends the in-cabin space mode. This allows reliable ending of the in-cabin space mode when the driver moves to the driver’s seat or starts driving.

As described above, in the processes S1 to S8, ECU 10 estimates the driver’s intention by utilizing the door sensor and voice operation, and provides proposals and operational assistance to the driver from vehicle V.

According to ECU 10, when it is determined that the driver has moved to the rear seat, the start process for the in-cabin space mode is executed. Thus, it is possible to start the in-cabin space mode from the rear seat after the driver has moved there. In this case, for example, the driver does not need to operate the touch panel display when starting and ending the in-cabin space mode, which reduces the complexity of operations required of the driver. As a result, the convenience for a driver using the in-cabin space mode is improved.

According to ECU 10, the movement information is information indicating whether a rear seat door of vehicle V is in an open state. Determination unit 12 determines that the driver has moved to the rear seat when it is determined that the rear seat door is open based on the movement information. For example, determination unit 12 determines that the driver has moved to the rear seat when the driver’s door opens and then a rear seat door opens. In this case, it is possible to determine with high accuracy whether the driver has moved to the rear seat, and proposing the in-cabin space mode based on the rear seat door open/close state improves convenience for the driver who has moved to the rear seat to use the in-cabin space mode.

According to ECU 10, in the start process control unit 13 requests consent to start the in-cabin space mode from the driver, and starts the in-cabin space mode when consent is received from the driver. In this case, it is possible to easily start the in-cabin space mode from the rear seat after the driver has moved there.

According to ECU 10, determination unit 12 determines whether the driver has moved from the rear seat, and control unit 13 ends the in-cabin space mode when determination unit 12 determines that the driver has moved from the rear seat after the in-cabin space mode has started. In this case, it is possible to reliably end the in-cabin space mode when the driver moves to the driver’s seat or begins driving.

According to ECU 10, storage unit 14 stores the types of and control contents for the plurality of in-vehicle devices activated by control unit 13 when vehicle V enters the in-cabin space mode. Even with such a storage unit 14, it is possible to improve convenience for a driver using the in-cabin space mode.

Although the example has been described above, the present disclosure is not limited to the above example, and various modifications are possible without departing from the scope of the disclosure.

In the above example, the movement information was the door open/close information and the operation information, but it is not limited to this. For example, the movement information may be position information indicating the driver’s position within the cabin. As shown in FIG. 1, an in-cabin camera 6 may be further connected to ECU 10. In-cabin camera 6 is a sensor capable of detecting an occupant’s (particularly the driver’s) position in the cabin. In-cabin camera 6 transmits position information indicating the detected driver’s position to ECU 10 as movement information. In this case, determination unit 12 may improve the accuracy of determining whether the driver has moved to the rear seat, the accuracy of determining the target seat for the in-cabin space mode, and the accuracy of determining whether to end the in-cabin space mode, based on the movement information as exemplified below.

That is, for example, when in-cabin camera 6 detects that the driver has moved to the left rear seat after ending driving, determination unit 12 may determine that the driver has moved to the rear seat. In this case, control unit 13 requests consent to start the in-cabin space mode by outputting audio such as “Start the in-cabin space mode for the left rear seat?” to the cabin. Also, for example, when in-cabin camera 6 detects that the driver has moved to the driver’s seat while the in-cabin space mode is being executed, determination unit 12 may determine that the driver has moved to the driver’s seat. In this case, control unit 13 ends the in-cabin space mode.

In the ECU 10 according to this modification, the movement information is position information indicating the driver’s position in the cabin. In this case, it is possible to accurately determine that the driver has moved to the rear seat and reliably start the in-cabin space mode, further improving driver convenience. In addition, it is possible to propose starting the in-cabin space mode for the seat on which the driver is seated with high accuracy. Furthermore, in this modification of ECU 10, when the driver moves to the driver’s seat (for example, when the driver starts driving), it is possible to accurately determine that the driver has moved to the driver’s seat and reliably end the in-cabin space mode.

Each configuration in the above example or modifications may be applied to other examples or modifications as appropriate. Parts of each configuration in the above example or modifications may be omitted as appropriate without departing from the gist of an aspect of the present disclosure.

What is claimed is:

1. A vehicle control apparatus to be mounted on a vehicle and configured to execute an in-cabin space mode in which a plurality of in-vehicle devices provided in the vehicle operate cooperatively, the vehicle control apparatus comprising:
an acquisition unit that acquires movement information regarding a user’s movement within the vehicle;
a determination unit that determines, based on the movement information, whether the user has moved to a rear seat of the vehicle; and
a control unit that executes a start process for starting the in-cabin space mode when the determination unit determines that the user has moved to the rear seat.

2. The vehicle control apparatus according to claim 1,
wherein the movement information is information indicating whether a rear seat door of the vehicle is in an open state, and
the determination unit determines that the user has moved to the rear seat when the movement information indicates that the rear seat door is in an open state.

3. The vehicle control apparatus according to claim 1,
wherein the control unit, in the start process, requests consent from the user to start the in-cabin space mode, and starts the in-cabin space mode when consent is received from the user.

4. The vehicle control apparatus according to claim 1,
wherein the determination unit determines, based on the movement information, whether the user has moved from the rear seat, and
the control unit ends the in-cabin space mode when the determination unit determines that the user has moved from the rear seat after the in-cabin space mode has started.

5. The vehicle control apparatus according to claim 1, further comprising a storage unit that stores types and control contents of the plurality of in-vehicle devices that are activated by the control unit when the vehicle enters the in-cabin space mode.
